(19) United States
(12) Patent Application Publication
(10) Pub. No.: US 2006/0050695 A1
(43) Pub. Date: Mar. 9, 2006

(54) System and method for using redundant representations in streaming applications

(75) Inventor: Ye-Kui Wang, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/935,489

(22) Filed: Sep. 7, 2004

(51) Int. Cl. H04L 12/56

(52) U.S. Cl. 370/389

(57) ABSTRACT

A system and method for stopping temporal propagation by avoiding using erroneous reference pictures in the streaming of pre-encoded and stored media contents. At least one redundant representation for a picture, referred to as the primary representation, is encoded and stored in a file. When encoding the redundant representation, some reference pictures are not used for inter prediction. In the streaming process, the server maintains the correctness of a list of reference pictures based upon feedback from the device. For the next-to-send picture, selection of a proper representation among the primary and redundant representations is performed such that the sent picture does not use an incorrect picture for inter prediction.

### FIELD OF THE INVENTION

The present invention relates to the streaming of pre-encoded and stored contents. More particularly, the present invention relates to the improvement of error resilience in the streaming of pre-coded and stored contents.

### BACKGROUND OF THE INVENTION

Streaming refers to the ability of an application to play synchronized media streams, such as audio and video streams, in a continuous way while those streams are being transmitted to a client over a data network. Applications, which can be built on top of streaming services, can be classified into on-demand and live information delivery applications. Examples of on-demand video applications include music and news-on-demand applications. Live deliveries of radio and television programs are examples of live information delivery applications.

The 3GPP packet-switched streaming service (PSS) provides a framework for Internet Protocol (IP) based streaming applications over “third generation” (3G) wireless networks.

The 3GPP transparent end-to-end packet-switched streaming service specifications consists of seven 3GPP TSs: 3GPP TS 22.233, 3GPP TS 26.233, 3GPP TS 26.234, 3GPP TS 26.235, 3GPP TS 26.244, 3GPP TS 26.245, and 3GPP TS 26.246. The TS 22.233 contains the service requirements for the PSS. The TS 26.233 provides an overview of the PSS. The TS 26.234 provides the details of protocol and codecs used by the PSS. The TS 26.235 provides the default codecs specification. The TS 26.244 defines the 3GPP file format (3GP) used by the PSS and multimedia messaging services (MMS). The TS 26.245 defines the timed text format used by the PSS. The TS 26.246 defines the 3GPP SMIL language profile.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 or ISO/IEC MPEG-4 AVC. H.264/AVC is the work output of a Joint Video Team (JVT) of ITU-T Video Coding Experts Group (VCEG) and ISO/IEC MPEG.

All available video coding standards utilize motion compensation, i.e. predictive coding, to remove temporal redundancy between video signals for high coding efficiency. In motion compensation, one or more previously decoded pictures are used as reference pictures of the current picture being encoded or decoded. When encoding one block of pixels of the current picture (the current block), a reference block from the reference picture is searched such that the difference signal between the current block and the reference block requires the minimum number of bits to represent. Encoding of the displacement between the current block and the reference block may also be considered in searching the reference block.

Although the use of reference pictures improves coding efficiency, it also makes the coded bit stream more vulnerable to transmission errors. An error in a reference picture typically will be propagated until the next refresh picture, which is typically intra coded without using motion compensation from any reference pictures.

FIG. 1 shows a conventional generic video communication system 10 as including a server or transmitter 12 and a client or receiver 14. The transmitter 12 includes a transmitter transport coder 18 and may also include a transmitter source coder 16. The transmitter source coder 16 takes as input uncompressed images and outputs coded video stream. The transmitter transport coder 18 encapsulates the compressed video according to the transport protocols in use. The receiver 14 performs inverse operations, i.e., transport decoding using a receiver transport decoder 20 and source decoding using a receiver source decoder 22, to obtain a reconstructed video signal. In the event that the transmitter 12 does not include a transmitter source coder 16, the transmitter 12 reads the bit stream or encapsulated packets from a file. If encapsulated packets are stored, the transmitter 12 may not require a transmitter transport coder 18 as well. The transmitter 12 also includes a memory unit 17 for storing computer code and a data communication link 19, which can be in wired or wireless form, for communicating with the receiver 14. Similar components also exist in the receiver 14.

During transmission, many video communication systems undergo transmission errors. Because of predictive coding, which is extensively applied in video coding to achieve high compression efficiency, transmission errors will not only affect the decoding quality of the current picture but also be propagated to subsequent predictively coded pictures. Without control of temporal error propagation, image quality may become seriously degraded or completely corrupted.

Techniques for preventing temporal error propagation include non-interactive methods and interactive methods. Non-interactive methods do not involve interaction between the transmitter 12 and the receiver 14. For systems where feedback information cannot be used, non-interactive methods have to be employed to prevent temporal error propagation. Non-interactive methods include forward error correction (FEC), which is performed in the transport coding layer, and intra refresh (in terms of either macroblock or picture), which is performed in the source coding layer.

Interactive methods refer to techniques where the recipient transmits information about corrupted decoded areas and/or transport packets to the transmitter 12. The communication system includes a mechanism to convey such feedback information. For example, in ITU-T H.323 and H.324 video conferencing standards, the receiver 14 can request an intra update of an entire picture or certain macroblocks using the H.245 control protocol. The transmitter 12 typically responds to such a request by coding the requested area in intra-mode in the next picture to be coded. Furthermore, the transmitter 12 may also use retransmission for recovery of the lost data. In applications with on-the-fly encoding, the transmitter 12 may use the reference picture selection technique according to the feedback information such that encoding of the next-to-send picture does not use any reference pictures that are erroneous due to transmission errors. Various error control methods are discussed in Y. Wang and Q.-F. Zhu, “Error control and concealment for video communication: a review,” Proc. IEEE, vol. 86, no. 5, May 1998, pp. 974-997, incorporated herein by reference.

MPEG-4 Part 12 specifies ISO base media file format. It is designed to contain timed media information for a presentation in a flexible, extensible format that facilitates interchange, management, editing, and presentation of the media. This presentation may be ‘local’ to the system containing the presentation, or may be via a network or other stream delivery mechanism. The file structure is object-oriented; a file can be decomposed into constituent objects very simply, and the structure of the objects inferred directly from their type. The file format is designed to be independent of any particular network protocol while enabling efficient support for them in general. ISO base media file format is used as the basis for MP4 file format (MPEG-4 Part 14), AVC file format (MPEG-4 Part 15), 3GPP file format (3GPP TS 26.244) and many other media file formats.

The H.264/AVC coding standard includes a technical feature called a redundant picture. A redundant picture is a redundant coded representation of a picture, called a primary picture, or a portion of a picture. Each primary coded picture may have a number of redundant pictures. After decoding, the region represented by a redundant picture should be similar in quality as the same region represented by the corresponding primary picture. The redundant picture technique can be applied to control transmission errors in the following way: if a region represented in the primary picture is lost or corrupted due to transmission errors, a correctly received and decoded redundant picture that contains the same region can be used to reconstruct the region. This method is also referred to as the straightforward use of redundant pictures.

The H.264/AVC coding standard supports SP/SI pictures. An SP/SI picture is encoded in the way such that another SP/SI picture using different reference pictures can have exactly the same reconstructed picture. SP/SI pictures can be applied for bit stream switching, splicing, random access, fast forward, fast backward and error resilience/recovery. For example, in a situation where there are two bit streams, bs1 and bs2, of different bit rates, originated from the same video sequence, in bs1, an SP picture (s1) is coded, and another SP picture (s2) is coded at the same location in bs2. In bs1, an additional SP picture (s12) is coded having exactly the same reconstructed picture as s2. s12 and s2 use different reference pictures (from bs1 and bs2, respectively). Thus, switching from bs1 to bs2 can be done by transmitting s12 instead of s1 in the switching location. Since s12 has exactly the same reconstruction as s2, reconstructed pictures after switching can be error-free.

As discussed above, reference picture selection can be efficiently utilized to improve error resilience in multimedia applications with on-the-fly encoding based on decoder-side feedback to the encoder. However, this method has not been able to improve error resilience of multimedia applications with pre-encoded and stored contents.

### SUMMARY OF THE INVENTION

The present invention addresses the shortcomings identified above by enabling the use of reference picture selection to improve error resilience in streaming of pre-encoded and stored contents. This is accomplished by the selection and transmission of a proper media representation for the next media frame to be sent.

The present invention provides users with a number of significant advantages over the prior art. For example, but without limitation, the present invention provides the ability to stop temporal error propagation by avoiding using erroneous reference pictures in streaming of pre-encoded and stored video contents. The present invention can also significantly improve error resilience, which therefore significantly improves end user-experienced streaming quality. The present invention also does not affect the coding efficiency if the transmission is error-free. The present invention can be used with most video codecs, such as H.264/AVC, H.263 with support of Annex N (RPS) or Annex U (ERPS), MPEG-4 Visual with support of NewPred or any other video code which supports selection of reference pictures. The present invention is applicable to both wireless 3GPP streaming applications, as well as wired or wireless Internet streaming applications.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of a generic video communication system including a transmitter and a receiver;

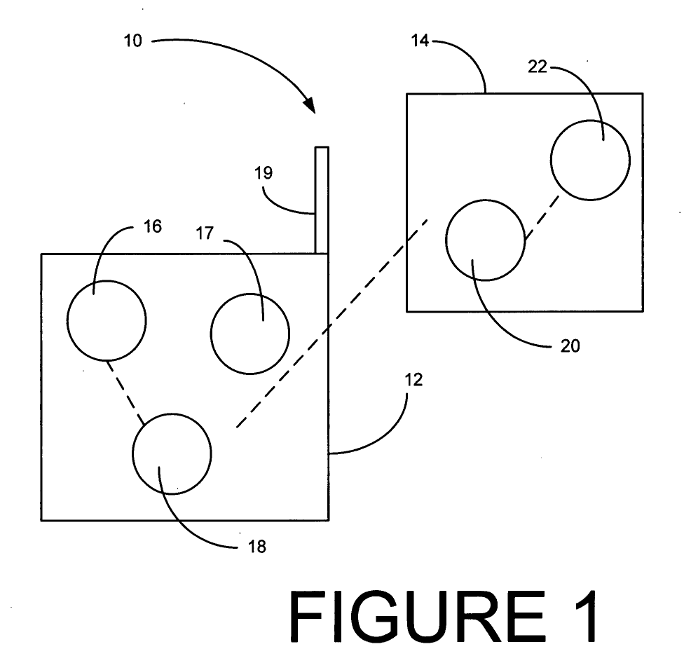

FIG. 2 is a flow diagram showing a process for improving error resilience in streaming of pre-encoded and stored contents according to a first embodiment of the invention;

FIG. 3 is a flow diagram showing a process for improving error resilience in streaming of pre-encoded and stored contents according to a second embodiment of the invention; and

FIG. 4 is a flow diagram showing a process for improving error resilience in streaming of pre-encoded and stored contents according to a third embodiment of the invention.

### DETAILED DESCRIPTION OF THE PREFERRED EMBODIMENTS

The present invention enables the use of reference picture selection to improve error resilience in streaming of pre-encoded and stored contents. This is accomplished by the selection and transmission of a proper media representation for the next media frame to be sent. The present invention provides a complete solution to improve streaming video quality in an error-prone environment by utilizing reference picture selection according to client feedback information. The present invention is particularly useful in low-delay streaming applications.

The present invention includes various aspects, including the encoding of redundant representations with on-purpose selected reference pictures, and two improvements for the encoding, namely the use of rate control to make the redundant representations having closer bit rate than the original representation and the use of SP/SI pictures to prevent error drifting. The present invention also covers the storage of redundant representations in a file format container, as well as the signaling of whether a reference picture is correct from the receiver 14 to the server or transmitter 12. In the present invention, the correct/erroneous status of reference pictures in the transmitter 12 is maintained and a proper representation of the next picture to serve to the receiver 14 is selected. Lastly, the present invention also enables the negotiation of the use of redundant representations between the transmitter 12 and the receiver 14.

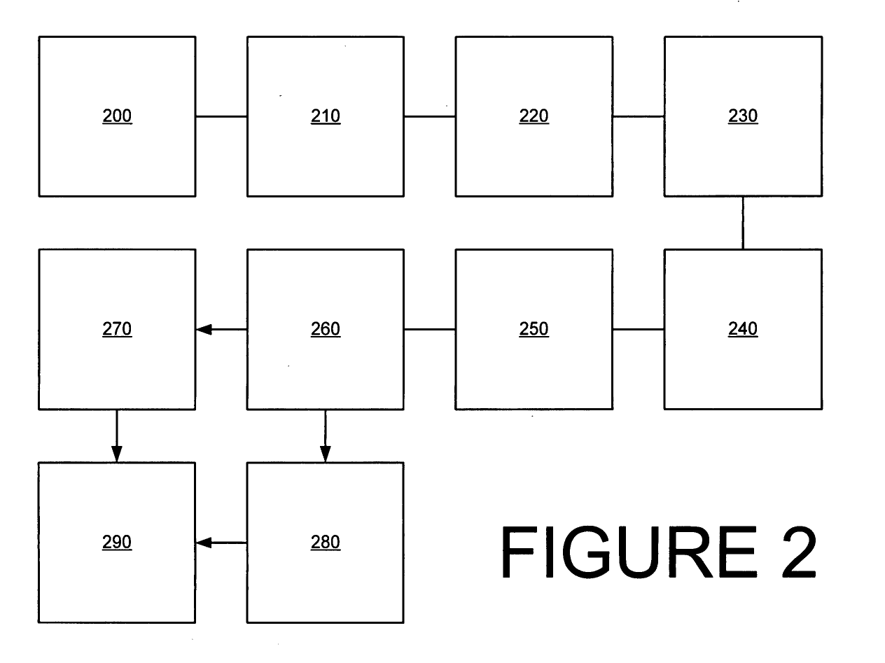

There are several possible streaming server and receiver 14 operations available using the present invention. One such operation involves the situation where retransmission is not used. This situation is applicable to streaming applications that do not use retransmission to save transmission bandwidth, or where the system does not support retransmission, regardless of the end-to-end delay. In this situation, there is no additional implementation requirement for the receiver 14 to implement the present invention. This scenario is represented in FIG. 2. In this scenario, the transmitter 12 begins to transmit packets to the receiver 14 at step 200. If one or more packets are lost during transmission at step 210, then the receiver 14 reports packet losses at step 220, using Real-time Transport Control Protocol (RTCP), for example. The transmitter 12 then receives the packet loss reports at step 230. Based on the packet loss reports, the transmitter 12 determines which reference pictures have been entirely or partially lost at step 240. To accomplish this task, the transmitter 12 needs to know the information of whether a packet contains at least a part from a reference picture.

In addition, at step 250 the transmitter 12 runs a simple error tracking algorithm to obtain information on whether a reference picture is correct or not. This algorithm is subsequently discussed herein. The transmitter 12 at 260 selects such a representation for the next-to-send picture that erroneous reference pictures have not been used in the encoding. If the primary representation meets the requirement or if there is no qualified redundant representation available, the primary representation is selected at step 270. Otherwise, a qualified redundant representation is selected at step 280. If there is more than one qualified redundant representation, the qualified redundant representation with the smallest size is selected, for example. It is also possible to select a qualified redundant representation based upon other criteria. The receiver 14 then receives the selected picture at step 290. After decoding, the temporal error propagation due to packet losses can be stopped if the primary representation meets the requirement, or if there is at least one qualified redundant representation.

In a second scenario, retransmission is used in streaming applications, regardless of the end-to-end delay. As is the case where there is no retransmission, with retransmission there is no additional implementation requirement for the receiver 14 to use the invention in this case. In this case, however, the delay between the first sending time of a packet of a reference picture and the time getting whether the reference picture is correct is increased. Consequently, the temporal distance between the next-to-send picture and the latest reference picture whose correctness is known increases. This increased temporal distance raises the probability that the latest reference picture whose correctness is known is out of the scope of the possible reference pictures of the next-to-send picture.

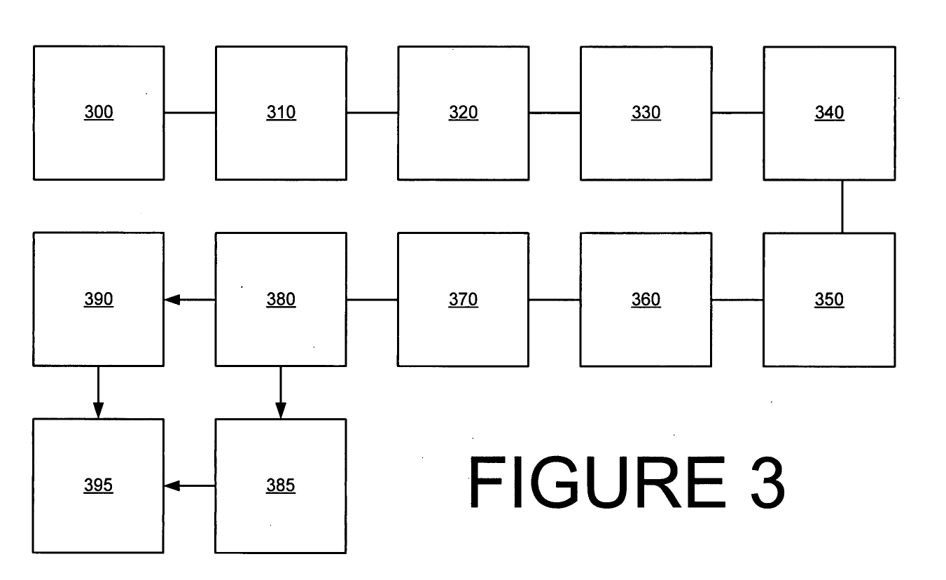

When retransmission is used, as represented in FIG. 3, the first step in reducing and/or eliminating error propagation involves having the transmitter 12 start to transmit packets to the receiver 14 at step 300. When one or more packets are lost during transmission at step 310, the receiver 14 reports packet losses at step 320, using RTCP, for example. The transmitter 12 then receives the packet loss reports at step 330, and some or all of the lost packets are retransmitted at step 340. The receiver 14 proceeds to report lost packets, including retransmitted packets, at step 350. The transmitter 12 then receives the packet loss reports at step 360, and retransmission can occur as necessary and/or as desired. Based on the packet loss reports, the transmitter 12 learns which reference pictures have been entirely or partially lost after retransmission at step 370 (as in the case where there is no retransmission, for this the transmitter 12 needs to know the information whether a packet contains at least a part from a reference picture). In addition, the transmitter 12 runs a simple error tracking algorithm at step 380 to obtain information whether a reference picture is correct or not. The simple error tracking algorithm is the same algorithm used for the case where there is no retransmission and is subsequently discussed. If the primary representation meets the requirement, or if there is no qualified redundant representation available, the primary representation is selected at step 385. Otherwise, a qualified redundant representation is selected at step 390. If there is more than one qualified redundant representation, the qualified redundant representation with the smallest size is selected, for example. It is also possible to select a qualified redundant representation based upon other criteria. The receiver 14 then receives the selected picture at step 395. After decoding, the temporal error propagation due to packet losses can be stopped if the primary representation meets the requirement, or if there is at least one qualified redundant representation.

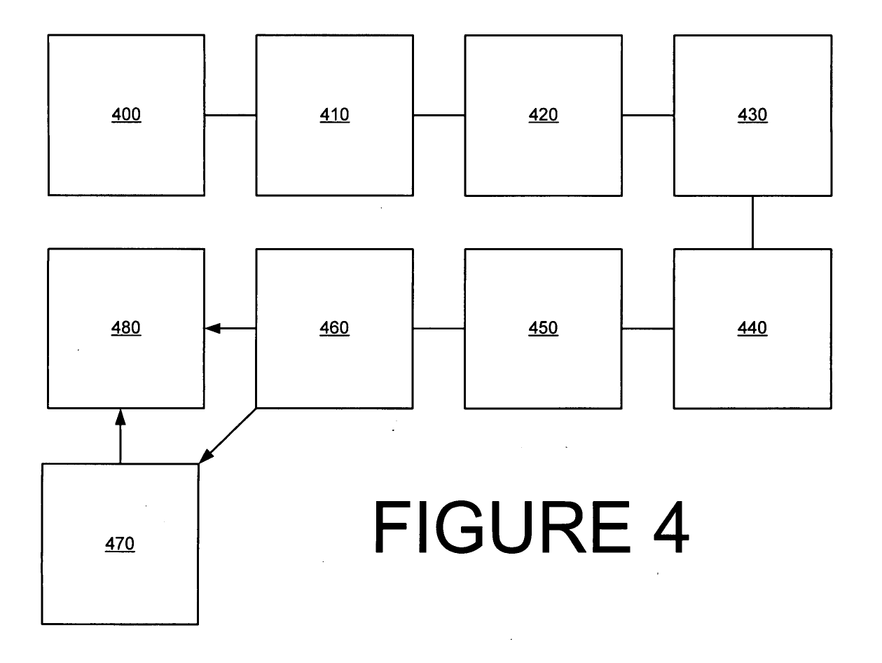

A third scenario involves the situation where a streaming application has a low end-to-end delay, including initial stream buffering delay, regardless of whether retransmission is used. As can be seen from the following operation steps, the receiver 14 needs to perform, and the transmitter 12 needs to understand, the report of reference picture correctness or erroneousness. In this scenario, represented in FIG. 4, the transmitter 12 first initiates transmission of packets to the receiver 14 at step 400. In the event that one or more possibly retransmitted packets are lost during transmission at step 410, the receiver 14 learns which reference pictures have been entirely or partially lost at step 420, possibly after retransmission. The receiver 14 also runs an error tracking algorithm at step 430 to obtain the information on whether a reference pictures is correct or not. The error tracking algorithm may be the same algorithm used in the two scenarios discussed previously, or an entirely different algorithm, as is later discussed. The receiver 14 then reports reference picture correctness or erroneousness at step 440, after which the transmitter 12 receives the reports of reference picture correctness or erroneousness at step 450. Based on the reports, the transmitter 12 selects such a representation for the next-to-send picture for which erroneous reference pictures have not been used in the encoding. If the primary representation meets the requirement, or if there is no qualified redundant representation is available, the primary representation is selected at step 460. Otherwise, a qualified redundant representation is selected at step 470. If there is more than one qualified redundant representation, the redundant representation with the smallest size is selected, for example. It is also possible to select a qualified redundant representation based upon other criteria. The receiver 14 then receives the selected picture at step 480, after which the decoding of temporal error propagation due to packet losses (possibly after retransmission) can be stopped if the primary representation meets the requirement, or if there is at least one qualified redundant representation. In each of these scenarios, computer program code stored within the transmitter 12 and/or the receiver 14 is used to execute the necessary functions.

The following is a discussion of the encoding of redundant representations with on-purpose selected reference pictures according to the present invention. Currently, H.264/AVC includes the coding of redundant pictures, where the redundant pictures of a corresponding primary picture are within the same access unit (and therefore the same bit stream) as the primary picture. A redundant picture is a redundant coded representation of a picture, called a primary picture, or a portion of a picture. Each primary coded picture may have a number of redundant pictures. If an H.264/AVC coded video sequence contains redundant pictures, the syntax element “redundant_pic_cnt_present_flag” in the picture sequence parameter set is 1, and the syntax element “redundant_pic_cnt” is present to differentiate between the primary picture and the redundant pictures.

In terms of the present invention, the term “redundant representation” refers to an additional coded representation of a picture or primary representation. The redundant representation covers the entire picture region. Each primary redundant representation may have zero or more redundant representations in the same bit stream or somewhere else (e.g. another track in the file format container).

There are a number of differences between a redundant representation and a redundant picture. A redundant picture, if it covers the entire picture region, is a special case of a redundant representation. A redundant representation is not necessarily in the same bit stream as the primary representation, while a conventional redundant picture must be in the same bit stream as the primary picture. Furthermore, when not in the same bit stream, a redundant representation and the corresponding primary representation do not need to contain any syntax element to be distinguished from each other. This allows the use of redundant representations with video codecs without support of redundant pictures, e.g. H.263 and MPEG-4 Visual.

The encoding of redundant representations is similar to the encoding of redundant pictures. To make the redundant representations (when selected and transmitted by the streaming server or transmitter 12) capable of preventing temporal error propagation, an additional limitation on use of reference pictures is imposed during the encoding. For a number (typically one) of the redundant representations of a primary representation, the closest previous reference picture (in bit stream order) is not used during encoding. In this system, if in the streaming process an error (bit error or packet loss) affects the closest reference picture, the consequent error propagation can be stopped when the transmitter 12 sends such a redundant representation.

For a number (typically one) of the redundant representations of a primary representation, both the first and the second closest previous reference pictures (in bit stream order) are not used during encoding. In this manner, if in the streaming process errors (bit errors or packet losses) affect the first and/or second closest reference pictures, the consequent error propagation can be stopped when the transmitter 12 sends such a redundant representation. This limitation continues based upon the n closest previous reference points when all of the first to the (n−1)^{th} closest previous reference pictures (in bit stream order) are not used during encoding. In such a way, if in the streaming process errors (bit errors or packet losses) affect any of the first to the (n−1)^{th} closest previous reference pictures, the consequent error propagation can be stopped when the transmitter 12 sends such a redundant representation.

In an extreme case, for some (typically one) of the redundant representations of a primary representation, no reference picture is used during encoding (i.e., those redundant representations are intra coded). In this system, such a redundant representation can be used for picture refreshing and to prevent error propagation due to any error in previously transmitted pictures.

No coding constraint is required for the encoding of the primary representation. The decoding process of a redundant representation is the same as the decoding process for either a primary representation/picture or a redundant picture.

Rate control and bit allocation algorithms can be used during the encoding of redundant representations in order to make the resulting bit rate as close as possible to the primary representation. This can be used to avoid buffer overflow or underflow, or alternatively to make the resulting picture quality as close as possible to the primary representation to maximize the streaming quality.

A redundant representation can be coded as an SP or SI picture such that it has the same reconstruction as the primary representation, which is coded as an SP picture. In this system, if the redundant representation is transmitted instead of the primary representation, drifting-error-free steaming can be achieved. Redundant representations can be coded as SP/SI pictures periodically, randomly or adaptively in time, or each redundant representation can be coded as an SP or SI picture.

One method for storing redundant representations in a file format container involves having redundant representations that are in the same bit stream as the primary representation. These redundant representations are referred to as type I redundant representations. For type I redundant representations, the storage is the same as if there is no redundant representation. In other words, all of the encoded pictures, including primary representations and redundant representations of a bit stream, are stored in a media track. One example of this system is an H.264/AVC media track with redundant pictures that cover the entire picture region.

To aid in the server or transmitter selection of a proper representation (either the primary representation or a redundant representation) to serve, the reference picture selection that was completed when the encoding of each redundant representation is signaled for the transmitter's easy access. In addition, the size of each redundant representation is indicated. Otherwise, the transmitter 12 needs to perform complex bit stream analysis.

The following is one example of how the encoding of each redundant representation is signaled. A new box, referred to herein as Redundant Representation Information Box, is used to contain the information concerning redundant representations. The Redundant Representation Information Box, according to one embodiment of the present invention, is defined as follows:

| | |
|---|---|
| Box Type: | ‘rrnf’ |
| Container: | Sample Table Box (‘stbl’) |
| Mandatory: | No |
| Quantity: | Zero or one |

As discussed previously, a redundant representation is another coded representation of the primary representation. The redundant representation covers the entire picture region, and each primary redundant representation may have zero or more redundant representations. The primary and all the redundant representations form a sample. If “redundant_representation_count” in the syntax below is 0 for any entry, then those samples have no redundant representation information and no array follows.

The syntax for the Redundant Representation Information Box, according to one embodiment of the invention, is as follows.

```
aligned(8) class RedundantRepresentationInformationBox
  extends FullBox(‘rrnf’, version, 0) {
    unsigned int(32) entry_count;
      int i,j;
      for (i=0; i < entry_count; i++) {
        unsigned int(16) sample_delta;
        unsigned int(8) redundant_representation_count;
        if(redundant_representation_count > 0) {
          for (j=0; j < redundant_representation_count+1; j++) {
            unsigned int(8) ref_pic_info;
            if(version == 1)
            {
              unsigned int(32) representation_size;
            }
            else
            {
              unsigned int(16) representation_size;
          }
        }
      }
    }
  }
```

In the syntax described above, “version” is an integer that specifies the version of the redundant representation information box (0 or 1). “entry_count” is an integer that gives the number of entries in the following table. “sample_delta” is an integer that indicates the sample number to which the redundant representation information in each entry belongs. If the current entry is the first entry, the value of the “sample_delta” is equal to the sample number to which the redundant representation information in the current entry belongs, minus 1. Otherwise, the value is equal to the sample number to which the redundant representation information in the current entry belongs to, minus the sample number to which the redundant representation information in the previous entry belongs.

“redundant_representation_count” is an integer that specifies the number of redundant representations for the current sample. “ref_pic_info” is an integer indicating the selected reference pictures used during encoding of the representation. Value 0 indicates that there is no constraint on the selection and use of reference pictures. Value 1 indicates that the first closest previous reference picture (in bit stream order) is not used. Value n (wherein 1<n<255 in one embodiment of the invention) indicates that the n closest previous reference pictures (in bit stream order) are not used. Value 255 indicates that all reference pictures are not used and the representation is intra coded. “representation_size” is an integer that specifies the size, in bytes, of the current representation. The first representation (j=0) is the primary representation, and other representations are redundant representations. The size of the primary representation is defined as the position of the first byte of the first redundant representation (j=1) minus the position of the first byte of the current sample.

A second method for storing redundant representations in a file format container involves redundant representations that are not in the same bit stream as the primary representation. These are referred to as type II redundant representations. For type II redundant representations, it is preferable to store them in different chunks, called redundant chunks, than the primary chunk for the corresponding primary representations. Furthermore, it is also preferable that type II redundant representations be stored immediately after the media data of the chunks containing primary representations, and that redundant representations for the same primary representation be stored contiguously in the same chunk.

The number of redundant chunks is equal to the number of chunks for the primary representations, i.e., the “entry_count” in the Chunk Offset Box (either “ChunkOffsetBox” or “ChunkLargeOffsetBox”). Allocation of the redundant representations for a primary representation to the redundant chunk index is same as the allocation of the primary representation to the primary chunk index. The information of redundant representations is stored in two new boxes referred to as a Redundant Sample Size Box (‘rrsz’) and a Redundant Chunk Offset Box (‘rrco’). These boxes are discussed in detail below. Either none or both of the two boxes are present.

The definition of the Redundant Sample Size Box, according to one embodiment of the present invention, is defined as follows.

| | |
|---|---|
| Box Type: | ‘rrsz’ |
| Container: | Sample Table Box (‘stbl’) |
| Mandatory: | No |
| Quantity: | Zero or one |

The syntax of the Redundant Sample Size Box, according to one embodiment of the invention, is as follows.

```
aligned(8) class RedundantSampleSizeBox
  extends FullBox(‘rrsz’, version, 0) {
    unsigned int(32) entry_count;
    int k;
    for(k=0; k< entry_count; k++) {
      unsigned int(8) redundant_representation_count;
      int j;
      for(j=0; j < redundant_representation_count; j++) {
        unsigned int(8) ref_pic_info;
        if(version == 1)
        {
          unsigned int(32) representation_size;
        }
        else
        {
          unsigned int(16) representation_size;
        }
      }
    }
  }
```

Regarding the semantics of the above syntax, “version” is an integer that specifies the version of this box (0 or 1). “entry_count” is an integer that gives the number of entries in the following table. The value is equal to the number of primary representations or samples in the track. “redundant_representation_count” is an integer that specifies the number of redundant representations for the current sample.

“ref_pic_info” is an integer indicating the selected reference pictures used during encoding of the redundant representation. Value 0 indicates that there is no constraint on the selection and use of reference pictures. Value 1 indicates that the first closest previous reference picture (in bit stream order) is not used. Value n (1<n<255) indicates that the n closest previous reference pictures (in bit stream order) are not used. Value 255 indicates that all reference pictures are not used and the redundant representation is intra coded. “representation_size” is an integer that specifies the size, in bytes, of the current redundant representation.

The definition of the Redundant Chunk Offset Box, according to one embodiment of the present invention, is as follows.

| | |
|---|---|
| Box Type: | ‘rrco’ |
| Container: | Sample Table Box (‘stbl’) |
| Mandatory: | No |
| Quantity: | Zero or one |

The syntax of the Redundant Chunk Offset Box, according to one embodiment of the invention, is as follows:

```
aligned(8) class RedundantChunkOffsetBox
  extends FullBox(‘rrco’, version, 0) {
    int i;
    for (i=0; i < entry_count; i++) {
      if(version == 1)
      {
        unsigned int(64) chunk_offset;
      }
      else
      {
        unsigned int(32) chunk_offset;
      }
    }
  }
```

Regarding the semantics of the Redundant Chunk Offset Box, “entry_count” is an integer that gives the number of entries in the following table. The value is equal to the number of primary representations or samples in the track. “version” is an integer that specifies the version of this box (0 or 1). “chunk_offset” is a 32 or 64 bit integer that gives the offset of the start of a redundant chunk into its containing media file.

To signal whether a reference picture is correct, the receiver 14 needs first to obtain the information, and then to signal it. A simple error tracking algorithm can be used to get the information of whether a reference picture is correct. This algorithm is as follows. For an intra picture, if the picture is correctly received, it is correct. Otherwise, it is erroneous. For an inter picture, if the picture is correctly received, the previous intra picture is correct, and all of the inter reference pictures between the previous intra picture and the current inter picture are correct, it is correct. Otherwise it is erroneous. The intra picture in the above steps is an instantaneous decoding refresh (IDR) picture or similar for video codecs that support multiple reference pictures (e.g. H.264/AVC), which means that any picture after the intra picture in bit stream order cannot reference any picture prior to the intra picture in bit stream order.

A second, advanced tracking algorithm, can instead be used to obtain the information of whether a reference picture is correct or not. This advanced algorithm is as follows. For an intra picture, if picture is correctly received, it is correct. Otherwise, it is erroneous. For an inter picture, if the picture is correctly received and all of the picture's prediction reference pixels belong to correct pictures, it is correct. Otherwise, it is erroneous.

A reference picture can be identified from other reference pictures by using temporal information such temporal reference (H.263), video object plane time (MPEG-4 Visual), picture order count (H.264/AVC), RTP timestamp, or other information, including picture number, video object plane ID, and frame number. Although any of the above-identified methods can be used, to ease the operation in both the receiver 14 and the transmitter 12, the decoding order count of reference picture (DOCref) may be used for this purpose. The value of DOCref for the first reference picture is 0. The value of DOCref for a later reference picture is equal to the DOCref value of the previous reference picture in decoding order, plus one, then mode 65536 (such that the value can be represented using 16 bits).

The use of RTCP is a strong system for feeding back information of reference picture correctness. For example, a new type of RTCP APP packet can be devised and used to contain the reference picture identification information, as well as whether it is correct or erroneous. The format is dependent on the selected reference picture identification information and how the information is signaled. For example, information of erroneous reference pictures can be signaled, when an error occurs rarely. Information of correct reference pictures can be signaled in cases where an error occurs frequently. A third approach is to signal information of both erroneous and correct reference pictures. This option can be used to improve report reliability.

There are two different modes for the maintenance of the correct or erroneous status of reference pictures in the server or transmitter 12; one is based on packet loss reports, while the other is based on reference picture correctness reports. The number of the list of reference pictures whose correct/erroneous status required to be maintained depends on at least two factors. The first factor is the maximum number of reference pictures that could be used for encoding of one picture. The second factor is the delay between the sending of one picture and the receiving of the report indicating the correctness of the picture. An increase in either the maximum number or the delay results in an increase of the required number of the list of reference pictures.

Using the maintenance mode based upon packet loss reports, the transmitter 12 needs to obtain the information whether the picture is a reference picture, as well as whether the picture is an intra/IDR picture or an inter picture. No further information of the coded video data is necessary. Such information can be obtained by parsing into the video data unit header, e.g. picture header or the first byte of H.264/AVC NAL unit. For H.264/AVC, all such information can be found from the first byte of NAL unit.

Using the above-mentioned information, the packet loss reports and the simple error tracking algorithm described previously, the transmitter 12 can maintain the correct or erroneous status of a list of reference pictures. To identify each reference picture from the list, the RTP timestamp can be used. The value of the RTP timestamp can be mapped to one unique reference picture. Such mapping is important for the transmitter 12 in the selection of a proper representation of the next picture to the transmitter 12 to the receiver 14 according to the correctness of reference pictures.

Using the maintenance mode based upon reference picture correctness reports, the transmitter 12 dose not need to know the information whether the picture is a reference picture and whether the picture is an intra/IDR picture or an inter picture. Furthermore, no error tracking operation is required. Maintenance of the correct or erroneous status of reference pictures can be performed directly according to the reference picture correctness reports.

Before sending the next picture, the transmitter 12 has maintained the correct/erroneous status of a list of reference pictures. However, there may exist some recently sent reference pictures, the feedback information on which has not yet been received. For these reference pictures, it is assumed either that they have been correctly received or that they have not been correctly received. The simple error tracking algorithm can then be used to derive the correctness of each those reference pictures.

According to the correct/erroneous status of the reference pictures, the representation of the next to-send picture should have not used any erroneous reference pictures in encoding. Such a representation can be selected from the media file according to the storage methods described above.

To enable negotiation of the use of redundant representations between the transmitter 12 and the receiver 14, the receiver 14 first needs to let the transmitter 12 know whether it has the capability to report the information regarding whether a reference picture is correct. Adding one more device capability item can signal this information. Second, the transmitter 12 may need to inform the receiver 14 whether redundant representations are available. This can be accomplished using a new SDP attribute. Lastly, if the receiver 14 has the capability and the redundant representations are available, it may be agreed that redundant representations will be used according to the rules described above. If the receiver 14 does not have the capability to report the information whether a reference picture is correct but it generates and sends back standard RTCP reports, the server or transmitter 12 can decide by itself whether to use redundant representations, if present.

The present invention as described herein provides a number of significant advantages over conventional systems. For example, the present invention enables the elimination of temporal error propagation by avoiding using erroneous reference pictures in streaming of pre-encoded and stored video contents. The present invention therefore can significantly improve error resilience and therefore significantly improve the end user experienced streaming quality. The invention also does not affect the coding efficiency if the transmission is error-free. Use of the present invention adds little complexity for both streaming clients and servers, and the invention can be used with most video codecs, including, but not limited to, H.264/AVC, H.263 with support of Annex N (RPS) or Annex U (ERPS), MPEG-4 Visual with support of NewPred, and any other video codecs supporting selection of reference pictures. The present invention can also be used in both wireless 3GPP streaming applications and wired or wireless Internet streaming applications.

While several embodiments have been shown and described herein, it should be understood that changes and modifications can be made to the invention without departing from the invention in its broader aspects. Various features of the invention are defined in the following claims.

What is claimed is:

1. A method for controlling temporal error propagation in a media stream being transmitted to a receiving device, comprising the steps of:
transmitting a primary representation of a first picture to the receiving device;
selecting a representation for a next-to-send picture;
if the primary representation refers to any reference picture that is incorrect at the receiving device, selecting a qualified redundant representation that does not refer to a reference picture that is incorrect at the receiving device; and
transmitting the selected representation to the receiving device.

2. The method of claim 1, wherein the selected representation is transmitted to the receiving device in a plurality of one or more packets of information, and further comprising the steps of:
if at least one of the plurality of packets of information is not received by the receiving device, reporting packet losses to a transmitting device; and
having the transmitting device identify any reference pictures that were not correct at the receiving device due to packet losses based upon the report of packet losses.

3. The method of claim 2, wherein packet losses are reported to the transmitting device using a real-time transport control protocol (RTCP).

4. The method of claim 2, wherein the transmitting device identifies any reference picture that was not correct at the receiving device by running an error tracking algorithm.

5. The method of claim 2, further comprising the step of retransmitting the packets that were lost to the receiving device.

6. The method of claim 1, wherein if there exists more than one qualified redundant representation, the qualified redundant representation with the smallest size is selected for transmission to the receiving device.

7. The method of claim 1, wherein the selected representation is transmitted to the receiving device in a plurality of one or more packets of information, and further comprising the steps of:
having the receiving device determine whether a reference picture is correct; and
transmitting a report regarding the correctness of the reference picture from the receiving device to a transmitting device.

8. The method of claim 7, wherein information concerning the correctness of a reference picture is reported to the transmitting device using a real-time transport control protocol (RTCP).

9. The method of claim 8, wherein the information concerning the correctness of a reference picture is conveyed in an RTCP APP packet.

10. The method of claim 7, wherein the receiving device identifies any reference picture correctness by running an error tracking algorithm.

11. The method of claim 7, further comprising the step of retransmitting the packets that were lost to the receiving device.

12. The method of claim 1, wherein the qualified redundant representation is selected from a previously transmitted picture other than the most immediately previously transmitted picture.

13. The method of claim 1, wherein the qualified redundant representation is selected from a previously transmitted picture other than the two most immediately previously transmitted pictures.

14. The method of claim 1, wherein the qualified redundant representation is in the same bit stream as the primary representation.

15. The method of claim 1, wherein the qualified redundant representation is in a different bit stream than the primary representation.

16. A computer program product for controlling temporal error propagation in a media stream being transmitted to a receiving device, comprising:
computer code for transmitting a primary representation of a first picture to the receiving device;
computer code for selecting a representation for a next-to-send picture;
computer code for, if the primary representation refers to any reference picture that is incorrect at the receiving device, selecting a qualified redundant representation that does not refer to a reference picture that is incorrect at the receiving device; and
computer code for transmitting the selected representation to the receiving device.

17. The computer code of claim 16, further comprising a step of identifying any reference picture that were not correct at the receiving device by running an error tracking algorithm based upon a report of packet losses.

18. The computer code of claim 16, further comprising the step of retransmitting the packets that were lost to the receiving device.

19. The computer program product of claim 16, comprising step of selecting the smallest qualified redundant representation, if there exists more than one qualified redundant representation.

20. The computer program product of claim 16, comprising step of selecting qualified redundant representation from a previously transmitted picture other than the most immediately previously transmitted picture.

21. The computer program product of claim 19, comprising step of selecting qualified redundant representation from a previously transmitted picture other than the two most immediately previously transmitted pictures.

22. A computer program product for controlling temporal error propagation in a media stream being received from a transmitting device, comprising:
computer code to determine whether a reference picture is correct; and
transmitting a report regarding the correctness of the reference picture to a transmitting device.

23. The computer program product of claim 22, comprising an error tracking algorithm for determining that the packets of information are received correctly.

24. The computer program product of claim 22, comprising step of reporting information concerning the correctness of a reference picture is using a real-time transport control protocol (RTCP).

25. The method of claim 24, wherein the information concerning the correctness of a reference picture is conveyed in an RTCP APP packet.

26. A network element for controlling temporal error propagation in a media stream being transmitted from a transmitting device to a receiving device, comprising:
a source coder for transforming an uncompressed image including a primary representation into a video stream;
a transport coder for encapsulating the video stream for transmission;
a data communication link for transmitting the encapsulated video stream to a receiving device; and
a memory unit including:
computer code for transmitting a primary representation of a first picture to the receiving device;
computer code for selecting a representation for a next-to-send picture;
computer code for, if the primary representation refers to any reference picture that is incorrect at the receiving device, selecting a qualified redundant representation that does not refer to a reference picture that is incorrect at the device; and
computer code for transmitting the selected representation to the receiving device.

27. The network element of claim 26, wherein if there exists more than one qualified redundant representation, the qualified redundant representation with the smallest size is selected for transmission to the receiving device.

28. The network element of claim 26, wherein the qualified redundant representation is selected from a previously transmitted picture other than the most immediately previously transmitted picture.

29. The network element of claim 26, wherein the qualified redundant representation is selected from a previously transmitted picture other than the two most immediately previously transmitted pictures.

30. An electronic device for controlling temporal error propagation in a media stream being received from a transmitting device, the device comprising:
a data communication link for receiving the encapsulated video stream;
a transport coder for decapsulating the video stream;
a source coder for transforming the compressed video stream into an uncompressed image;
a memory unit including:
computer code to determine whether a reference picture is correct; and
transmitting a report regarding the correctness of the reference picture to a transmitting device.

31. The electronic device of claim 30, comprising an error tracking algorithm for determining that the packets of information are received correctly.

32. The electronic device of claim 30, wherein information concerning the correctness of a reference picture is reported to the transmitting device using a real-time transport control protocol (RTCP).

33. The electronic device of claim 32, wherein the information concerning the correctness of a reference picture is conveyed in an RTCP APP packet.

34. The electronic device of claim 19, wherein the qualified redundant representation is selected from a previously transmitted picture other than the most immediately previously transmitted picture.

35. A module for controlling temporal error propagation in a media stream, comprising:
a data communication link transmitting a primary representation of a picture to a receiving device; and
a memory unit including:
computer code for transmitting a primary representation of a first picture to the device;
computer code for selecting a representation for a next-to-send picture;
computer code for, if the primary representation refers to any reference picture that is incorrect at the device, selecting a qualified redundant representation that does not refer to a reference picture that is incorrect at the receiving device; and
computer code for transmitting the selected representation to the receiving device.

36. The module of claim 35, wherein if there exists more than one qualified redundant representation, the qualified redundant representation with the smallest size is selected for transmission to the receiving device.

37. The module of claim 35, wherein the qualified redundant representation is selected from a previously transmitted picture other than the most immediately previously transmitted picture.

38. The module of claim 35, wherein the qualified redundant representation is selected from a previously transmitted picture other than the two most immediately previously transmitted pictures.

39. The module of claim 35, wherein the qualified redundant representation is in the same bit stream as the primary representation.

40. The module of claim 35, wherein first qualified redundant representation is in a different bit stream than the primary representation.

41. A system for controlling error propagation in video streaming, comprising:
a transmitter for transmitting a plurality of packets of information to the receiver, the plurality of packets of information relating to a primary representation of a first picture; and
a receiver in communication with the transmitter,
wherein, if at least one of the plurality of packets of information is not received by the receiver, packet losses are reported to the transmitter using a real-time transport protocol, and wherein the transmitter identifies any reference pictures that were not received by the device due to packet losses based upon the report of packet losses from the receiver.

42. The system of claim 41, further comprising a mechanism for retransmitting the packets that were lost to the receiver.

43. The system of claim 41, wherein, if the primary representation refers to any reference picture that is incorrect at the receiver, a qualified redundant representation that does not refer to a reference picture that is incorrect at the receiver is selected and transmitted to the receiver.

44. The system of claim 41, wherein if there exists more than one qualified redundant representation, the qualified redundant representation with the smallest size is selected for transmission to the receiver from the transmitter.

45. The system of claim 41, wherein the qualified redundant representation is selected from a previously transmitted picture other than the most immediately previously transmitted picture.

46. The system of claim 41, wherein the qualified redundant representation is in the same bit stream as the primary representation.

47. The system of claim 41, wherein the qualified redundant representation is in a different bit stream than the primary representation.

48. A method for controlling temporal error propagation in a media stream being transmitted to a receiving device, comprising the steps of:
transmitting a primary representation of a first picture to the receiving device;
selecting a representation for a next-to-send picture;
if the primary representation refers to any reference picture that is incorrect at the receiving device, selecting a qualified redundant representation from a group of redundant representations that does not refer to a reference picture that is incorrect at the receiving device; and
transmitting the selected representation to the receiving device, wherein the group of redundant representations are stored in a file according to a media file format specification.

49. The method of claim 48, wherein the group of redundant representations are stored as a plurality of chunks.

50. The method of claim 48, wherein the media file format is the ISO base media file format.

51. The method of claim 48, wherein the media file format is the 3GPP file format.

52. The method of claim 48, wherein information concerning the group of redundant representations are stored in a Redundant Sample Size Box and a Redundant Chunk Offset Box.

53. The method of claim 48, wherein information concerning the group of redundant representations are stored in a Redundant Representation Information Box.

54. The method of claim 48, wherein the selected representation is transmitted to the receiving device in a plurality of one or more packets of information, and further comprising the steps of:
if at least one of the plurality of packets of information is not received by the receiving device, reporting packet losses to a transmitting device; and
having the transmitting device identify any reference pictures that were not correct at the receiving device due to packet losses based upon the report of packet losses.

55. The method of claim 54, wherein packet losses are reported to the transmitting device using a real-time transport control protocol (RTCP).

56. The method of claim 55, wherein the transmitting device identifies any reference picture that was not correct at the receiving device by running an error tracking algorithm.

57. The method of claim 54, further comprising the step of retransmitting the packets that were lost to the receiving device.

58. The method of claim 48, wherein if there exists more than one qualified redundant representation, the qualified redundant representation with the smallest size is selected for transmission to the receiving device.

59. The method of claim 48, wherein the selected representation is transmitted to the receiving device in a plurality of one or more packets of information, and further comprising the steps of:
having the receiving device determine whether a reference picture is correct; and
transmitting a report regarding the correctness of the reference picture from the receiving device to a transmitting device.

60. The method of claim 59, wherein information concerning the correctness of a reference picture is reported to the transmitting device using a real-time transport control protocol (RTCP).

61. The method of claim 60, wherein the information concerning the correctness of a reference picture is conveyed in an RTCP APP packet.

62. The method of claim 59, wherein the receiving device identifies any reference picture correctness by running an error tracking algorithm.

63. The method of claim 59, further comprising the step of retransmitting the packets that were lost to the receiving device.

64. The method of claim 48, wherein the qualified redundant representation is selected from a previously transmitted picture other than the most immediately previously transmitted picture.

65. The method of claim 48, wherein the qualified redundant representation is selected from a previously transmitted picture other than the two most immediately previously transmitted pictures.

66. The method of claim 48, wherein the qualified redundant representation is in the same bit stream as the primary representation.

67. The method of claim 48, wherein the qualified redundant representation is in a different bit stream than the primary representation.
